(19) United States
(12) Patent Application Publication
(10) Pub. No.: US 2005/0200737 A1
(43) Pub. Date: Sep. 15, 2005

(54) Protective structure for display unit, digital camera and image-related apparatus

(76) Inventors: Junichi Shinohara, Yokohama-shi (JP); Koji Yokoyama, Yokohama-shi (JP); Kimiharu Yanagisawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/056,297

(22) Filed: Feb. 14, 2005

(30) Foreign Application Priority Data
Feb. 18, 2004 (JP) 2004-042039

(51) Int. Cl. H04N 5/222

(52) U.S. Cl. 348/333.01

(57) ABSTRACT

A protective structure for a display unit including the display unit for displaying an image, and a plate-like protective member disposed at a side of a surface of the display unit on which the image is displayed for protecting the display surface of the display unit, wherein the protective member is directly fixed to the display unit.

### BACKGROUND OF THE INVENTION

1. Field of the Invention

The present invention relates to a protective structure for a display unit applicable to a digital camera or an image-related apparatus such as an image inputting device, an image displaying device and an image processing device and so on utilizing a liquid crystal display unit.

2. Description of the Related Art

Heretofore, there has been known a retaining structure of a display panel or a liquid crystal display portion in a digital camera or an image-related apparatus such as an image inputting device, an image displaying device and an image processing device and so on (for reference, see Japanese patent No. 3198044 and Japanese utility model registration No. 2568467).

Japanese patent No. 3198044 discloses a retaining structure of a display panel (or a liquid crystal display panel) using an elastic member, while Japanese utility model registration No. 2568467 discloses a retaining structure of a liquid crystal display portion. In either of them, an exterior cover is used to retain a LCD protective panel.

FIG. 7 is a perspective view schematically showing an external appearance of the back of a conventional digital camera. FIG. 8 is a perspective view schematically showing an external appearance of the front of the conventional digital camera shown in FIG. 7. The conventional digital camera 1 shown in FIGS. 7 and 8 has a mode dial 2, a shutter button 3, various operating switches 4, an eyepiece finder 5 and a liquid crystal protective panel (liquid crystal monitor portion) 6. The conventional digital camera 1 also has a strobe window 7, an objective finder 8 and a photographing lens 9.

It is often the case that the photographing lens 9 and the liquid crystal monitor portion are overlapped with each other in a thickness direction in the commonly used digital camera. Hence, thinning of the photographing lens 9 and thinning of the liquid crystal monitor portion are very important issues in order to accomplish thinning of the digital camera.

FIG. 9 is a block diagram showing a basic construction of the commonly used digital camera. As shown in FIG. 9, the digital camera 1 includes a strobe emitting portion 10, a strobe controlling portion 11, a ranging sensor controlling portion 12, a ranging sensor 13 and a temperature sensor 14.

In addition, the digital camera 1 has a lens barrel unit 15 including an LPF (Low Pass Filter) 16, an imaging device 17, a zoom driving system 18, a focus driving system 19 and a shutter/aperture driving system 20. An output of the imaging device 17 is transmitted to be connected to a system controller 21 through an A/D converter 22 and an image processing portion 23.

A release pressing portion 25 is connected to the system controller 21 through a camera operating portion 29, while a half-press detecting portion 26 and a full-press detecting portion 27 are also connected to the system controller 21. The system controller 21 is connected with a group of memories 24. An output from the system controller 21 is transmitted to a display portion (such as a monitor, an LCD display and an Auto-Focus LED) 28.

FIG. 10 is an enlarged back view showing a first case of the vicinity of a liquid crystal unit according to the conventional digital camera. FIG. 11 is a cross-sectional view taken along a line 11-11 in FIG. 10. In FIGS. 10 and 11, a liquid crystal unit 30 is disposed at a position inside of a back cover 31 and within a liquid crystal fixing frame (camera body) 32.

A dust proof sponge 33 is disposed between an opening 31a of the back cover 31 and the liquid crystal unit 30. The back cover 31 is provided with the finder 5. The first case is a type that a liquid crystal display portion is directly exposed externally without disposing a protection panel in front of a display surface of the liquid crystal unit 30.

Although the type according to the first case makes the construction of digital camera to be the thinnest, the display surface is easily damaged since the display surface is unprotected, which renders a user dissatisfactory in terms of a sense of relief.

FIG. 12 is an enlarged back view showing a second case of the vicinity of the liquid crystal unit according to the conventional digital camera. FIG. 13 is a cross-sectional view taken along a line 13-13 in FIG. 12. The entire construction shown in FIGS. 12 and 13 is similar to that of the first case shown in FIG. 11.

In the second case, the liquid crystal protective panel 6 covering the opening 31a of the back cover 31 is arranged. The liquid crystal protective panel 6 according to the second case is attached to the edge of the opening 31a of the back cover 31 with a two-side tape 34. The back cover 31 is also provided with the finder 5.

According to the second case, the protective panel 6 is arranged to protect the liquid crystal display portion from disturbance, and at the same time, to be able to obtain the sense of relief. However, since the liquid crystal protective panel 6 is received by the exterior cover 31 to retain the liquid crystal protective panel, there is a drawback that a thickness of camera increases corresponding to a thickness of liquid crystal protective panel.

Although the drawback can be solved by reducing the thickness of liquid crystal protective panel 6, in fact, since substantially equivalent strength is required in the liquid crystal protective panel 6 as well as in the exterior cover, it is unfavorable to make the liquid crystal protective panel 6 thin.

### SUMMARY OF THE INVENTION

Therefore, at least one objective of the present invention is to provide a protective structure for display unit in which a liquid crystal protective panel having sufficient strength is disposed within a thickness substantially equivalent to a thickness of a case where the liquid crystal protective panel is not disposed and capable of avoiding various risks associated with such a structure.

To achieve these and other advantages and in accordance with the purpose of the invention, as embodied and broadly described herein, the invention provides a protective structure for a display unit. The protective structure for the display unit comprises the display unit for displaying an image, and a plate-like protective member disposed at a side of a surface of the display unit on which the image is displayed for protecting the display surface of the display unit, wherein the protective member is directly fixed to the display unit.

The following are preferred embodiments (1) to (7) of the present invention, and any combinations thereof are considered to be preferred ones of the present invention unless any contradictions occur.

(1) Either one of a size in a longitudinal direction and a size in a lateral direction of the protective member is smaller than a corresponding outline size of the display unit.

(2) The present invention further comprises a cover member covering periphery of the display unit, wherein the display unit is disposed to be constrained by the cover member with respect to a direction perpendicular to the display surface at a portion of the display unit larger than a size of the protective member.

(3) The present invention further comprises a retaining member for retaining the display unit, wherein the retaining member is disposed to constrain the protective member with respect to a direction perpendicular to the display surface at a portion of the retaining member larger than a size of the display unit.

(4) The protective member is disposed such that a position in the longitudinal direction and/or a position in the lateral direction of the protective member are/is constrained by an opening portion of the cover member.

(5) The protective member is fixed to the display unit by an adhesive member having a configuration generally surrounding a display area of the display unit.

(6) A digital camera which comprises the protective structure for the display unit.

(7) An image-related apparatus which comprises the protective structure for the display unit.

According to the present invention, the protective member is fixed directly to the display unit, thereby it is possible to provide the protective structure for display unit in which the liquid crystal protective panel having the sufficient strength is disposed within the thickness substantially equivalent to the thickness of the case where the liquid crystal protective panel is not disposed and capable of avoiding the various risks associated with such a structure.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an enlarged back view showing the vicinity of a liquid crystal unit according to a first embodiment of the present invention of a digital camera.

FIG. 2 is a cross-sectional view taken along a line A-A in FIG. 1.

FIG. 3 is a cross-sectional view taken along a line B-B in FIG. 1.

FIG. 4 is an enlarged back view showing the vicinity of the liquid crystal unit according to a second embodiment of the present invention of the digital camera.

FIG. 5 is a cross-sectional view taken along a line C-C in FIG. 4.

FIG. 6 is a cross-sectional view taken along a line D-D in FIG. 4.

FIG. 7 is a perspective view schematically showing an external appearance of the back of a conventional digital camera.

FIG. 8 is a perspective view schematically showing an external appearance of the front of the conventional digital camera shown in FIG. 7.

FIG. 9 is a block diagram showing a basic construction of the commonly used digital camera.

FIG. 10 is an enlarged back view showing a first case of the vicinity of a liquid crystal unit according to the conventional digital camera.

FIG. 11 is a cross-sectional view taken along a line 11-11 in FIG. 10.

FIG. 12 is an enlarged back view showing a second case of the vicinity of the liquid crystal unit according to the conventional digital camera.

FIG. 13 is a cross-sectional view taken along a line 13-13 in FIG. 12.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

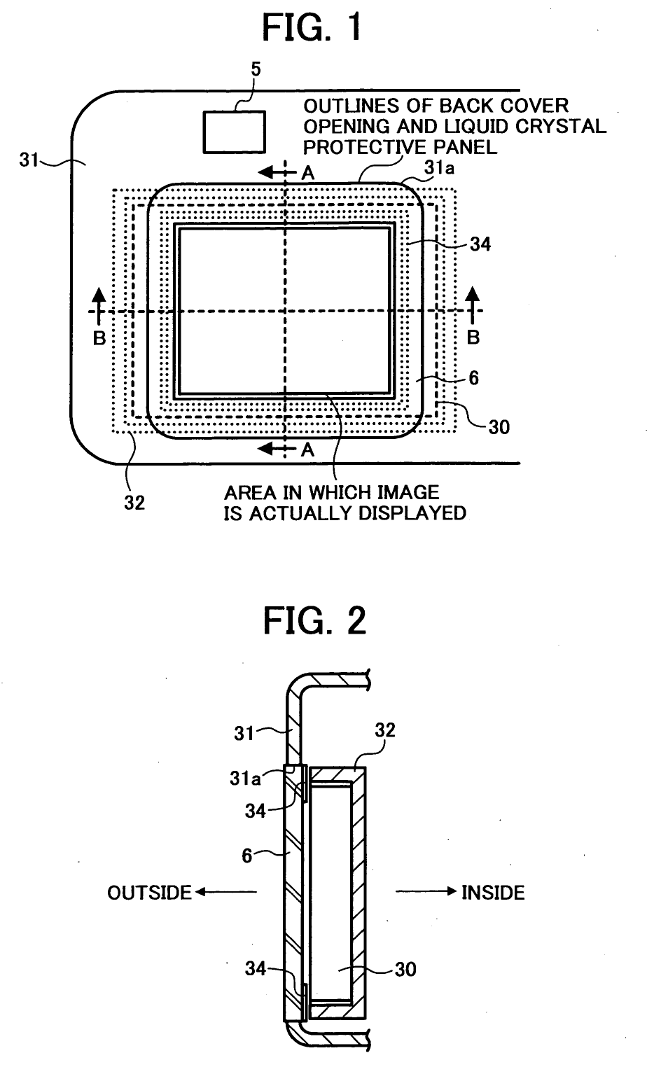

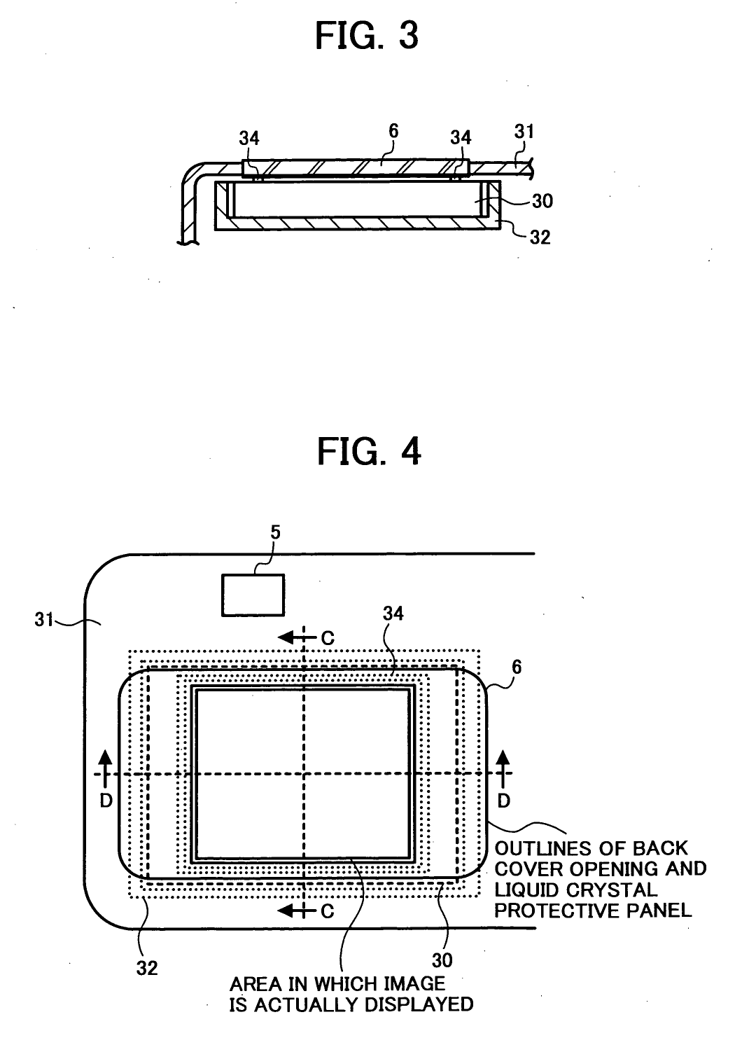

FIG. 1 is an enlarged back view showing the vicinity of a liquid crystal unit according to a first embodiment of the present invention of a digital camera. FIG. 2 is a cross-sectional view taken along a line A-A in FIG. 1. FIG. 3 is a cross-sectional view taken along a line B-B in FIG. 1. In addition, entire external views of a digital camera shown in FIGS. 7 and 8 as well as reference numbers used therein are referred to and used to explain the embodiments.

Referring to FIGS. 1 to 3, a liquid crystal protective panel 6 having sufficient strength is disposed within a thickness of the camera substantially equivalent to that of a case where the liquid crystal protective panel is not disposed. In order to accomplish this, it is required not to interpose anything between a plate-like protective member (liquid crystal protective panel) 6 which is for protecting or covering a display surface of a display unit (liquid crystal unit) and the liquid crystal unit 30. Hence, the liquid crystal protective panel 6 is directly fixed to the front peripheral edge (retaining member 32) of the liquid crystal unit 30. Here, it should be noted that the liquid crystal unit 30 is intended to include a liquid crystal fixing frame as the retaining member 32, and a body of camera.

The liquid crystal protective panel 6 is supported by fitting the liquid crystal protective panel 6 in an opening portion 31a of an exterior cover 31 to support the outer peripheral edge of the liquid crystal protective panel 6. Because the conventional example shown in FIG. 13 has a thin brattice at inner circumference of an opening portion 31a of an exterior cover 31 and a liquid crystal protective panel 6 is arranged on the brattice, an amount of protrusion of the liquid crystal protective panel 6 is large. In contrast, the present invention has no brattice or the like at the inner circumference of the opening portion 31a, so that it is possible to reduce the amount of protrusion of the liquid crystal panel 6.

Accordingly, since the exterior cover (cover member) 31 and the liquid crystal protective panel 6 have substantially the same thickness, it is possible to dispose the liquid crystal protective panel 6 without increasing the entire thickness of the camera. However, in order to cope with various problems which may occur by such a construction, minor refinements may be required.

First, it is not possible to sufficiently constrain a position of the liquid crystal protective panel 6 in an outer side direction perpendicular to the display surface only by combining the liquid crystal unit 30 and the liquid crystal protective panel 6 together. Accordingly, right and left end edge portions (end edges in a lateral direction) of the liquid crystal unit 30 are extended or deviated as compared with right and left end edges of the opening 31a inside of the back cover 31 as shown in FIG. 1, such that the position in the direction perpendicular to the display surface of the liquid crystal protective panel 6 is stabilized. Hence, the liquid crystal unit 30 combined with the liquid crystal protective panel 6 is constrained by the back cover 31 and thereby configured not to be protruded from the constrained position toward the outside. Therefore, it is possible to solve such a circumstance that the liquid crystal protective panel 6 is bulged unsightly.

Contrarily, it is also of a problem when the liquid crystal protective panel 6 is pressed inwardly and thereby the liquid crystal protective panel 6 is sunk down toward the inside. Accordingly, in the first embodiment, a size in a longitudinal direction of the liquid crystal protective panel 6 is arranged to be larger than a size in longitudinal direction of the liquid crystal unit 30 to adapt upper and lower end edge portions of the liquid crystal protective panel 6 extended or deviated in the upper and lower directions to be constrained by the rectangular-annular fixing member (liquid crystal fixing frame in the drawings) 32 fixed inside of the digital camera, so as to avoid the liquid crystal protective panel 6 to be sunk down when it is depressed. Reference numeral 34 denotes, for example but not limited to, a two-sided tape.

As described in the foregoing, by adapting at least either one of the size in the longitudinal direction and a size in a lateral direction of the liquid crystal protective panel 6 to be smaller than a corresponding outline size of the liquid crystal unit 30, and constructing the liquid crystal protective panel 6 and the liquid crystal unit 30 such that the longitudinal direction and the lateral direction thereof intersect with each other in a grid-like shape, it is possible to solve the above-mentioned two problems at the same time.

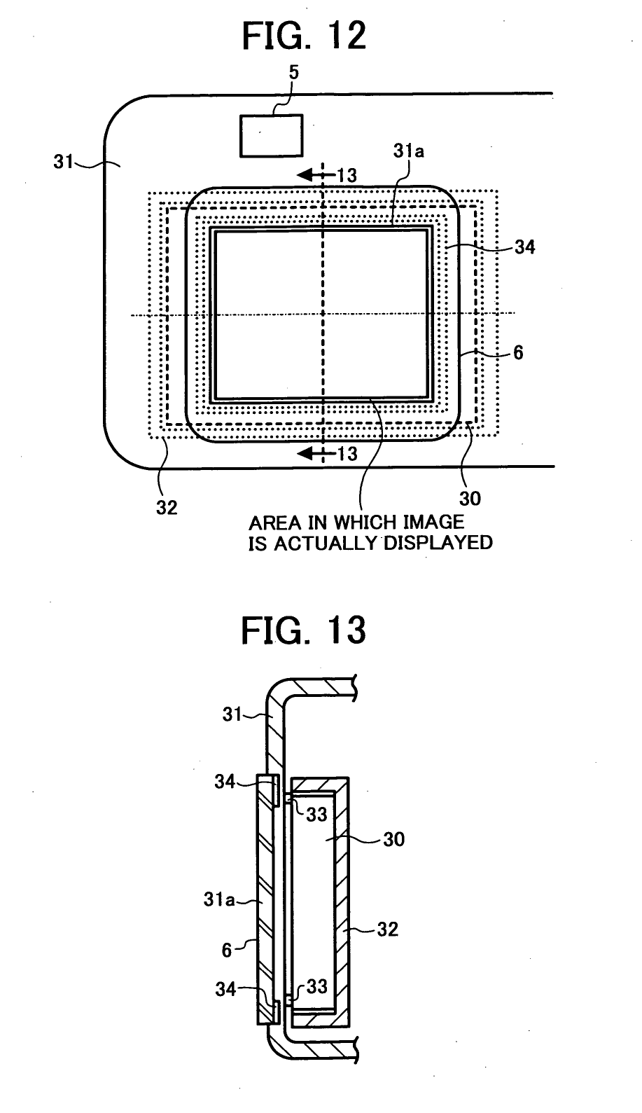

Secondly, there is a problem of how to decide the position of the liquid crystal protective panel 6 in the longitudinal and lateral directions. According to a type of a conventional example shown in FIG. 12, the positioning with respect to all directions is accomplished by the cover 31, since the liquid crystal protective panel 6 according to the conventional example is put into a concave portion provided on the back cover 31 of the liquid crystal protective panel 6.

However, according to the present invention, because the liquid crystal unit 30 is, for example but not limited to, a general-purpose product available commercially, to provide a concave or convex on the liquid crystal unit 30 will impair the general versatility and thus unfavorable. In addition, displacement of the back cover 31 and the liquid crystal unit 30 may directly increase a gap between the back cover 31 and the liquid crystal protective panel 6.

The problem of displacement still remains even when the liquid crystal protective panel 6 is positioned with a component within the digital camera (for example but not limited to, the liquid crystal fixing frame 32). Accordingly, the positioning in the longitudinal and lateral directions of the liquid crystal protective panel 6 is configured to be carried out with the back cover 31 rather than the liquid crystal unit 30, in the first embodiment of the present invention.

Hence, the liquid crystal protective panel 6 will be attached to the liquid crystal unit 30 after the liquid crystal unit 30 and the back cover 31 are combined, but this will not cause any particular problem in an assembly process. Also, in a case of disassembling such as repair, because the liquid crystal protective panel 6 is already positioned and attached to the liquid crystal unit 30, the disassembling can be carried out while the liquid crystal protective panel 6 is attached to the liquid crystal unit 30. Rather, it is advantages in that the liquid crystal display surface will not be tainted in the repair.

In addition, because adjustment of size is carried out on the one-to-one basis of the back cover 31 and the liquid crystal protective panel 6, it is possible to make the gap between the back cover 31 and the liquid crystal protective panel 6 at the minimum to improve the quality of external appearance.

Further, measures for intrusion of dust or the like into a space between the liquid crystal unit 30 and the liquid crystal protective panel 6, which are conventionally carried out with a member 33 such as a sponge, may be required.

Such measures can be attained by attaching the liquid crystal protective panel 6 to the liquid crystal unit 30 in such a manner as to encircle the periphery of a displayed portion (or a display area) of the liquid crystal unit 30 at the time of fixing the liquid crystal protective panel 6 to the liquid crystal unit 30. In practice, the liquid crystal protective panel 6 is fixed to the liquid crystal unit 30 with an adhesive member 34 which is, for example but not limited to, a two-sided tape. In one embodiment, the adhesive member has a configuration generally surrounding the display area of the display unit.

Accordingly, not only is it possible to avoid the intrusion of dust in the assembled state, but it is also possible to avoid the intrusion of new dust into the space between the liquid crystal unit 30 and the liquid crystal protective panel 6, since sealing in the space is maintained even at the time of repair or disassembling as explained above.

In addition, the members such as the two-sided tape are less expensive than the conventional sponge-type member, hence the cost reduction is possible. Practically, in the conventional examples, since the two-sided tape other than the dust-proof sponge is required to fix the liquid crystal protective panel 6 to the back cover 31, what makes the effective cost reduction possible is not a difference of cost between the conventional examples and the present invention, but rather, it is a fact that such a sponge is unnecessary.

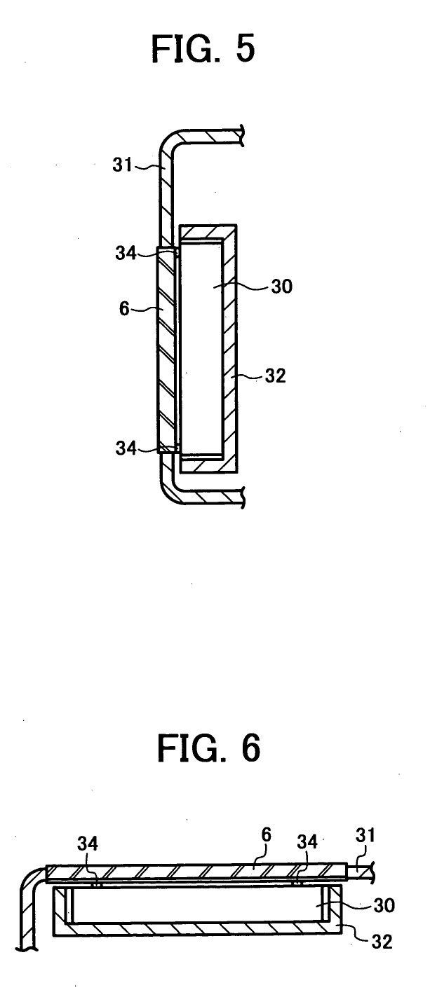

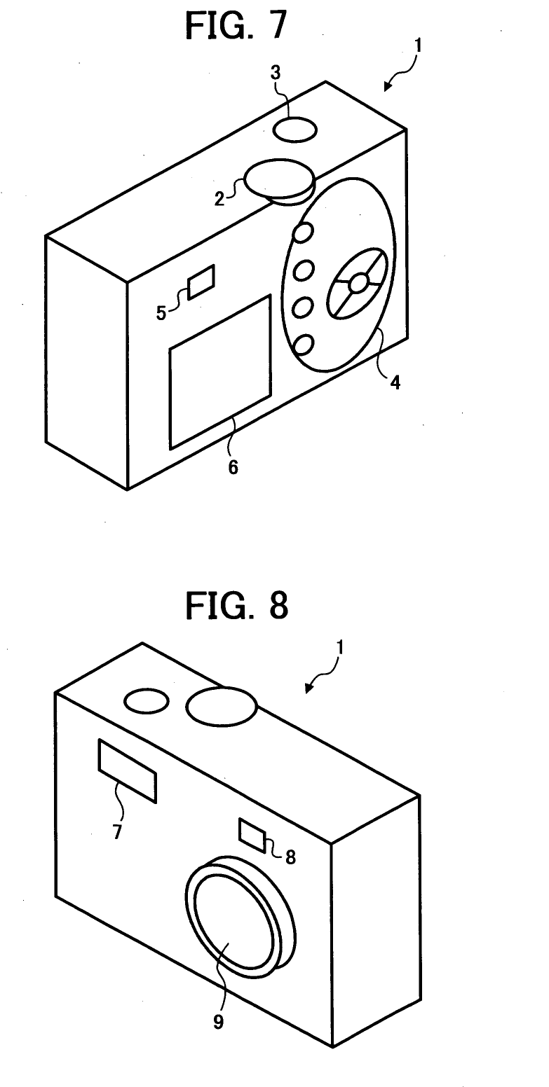

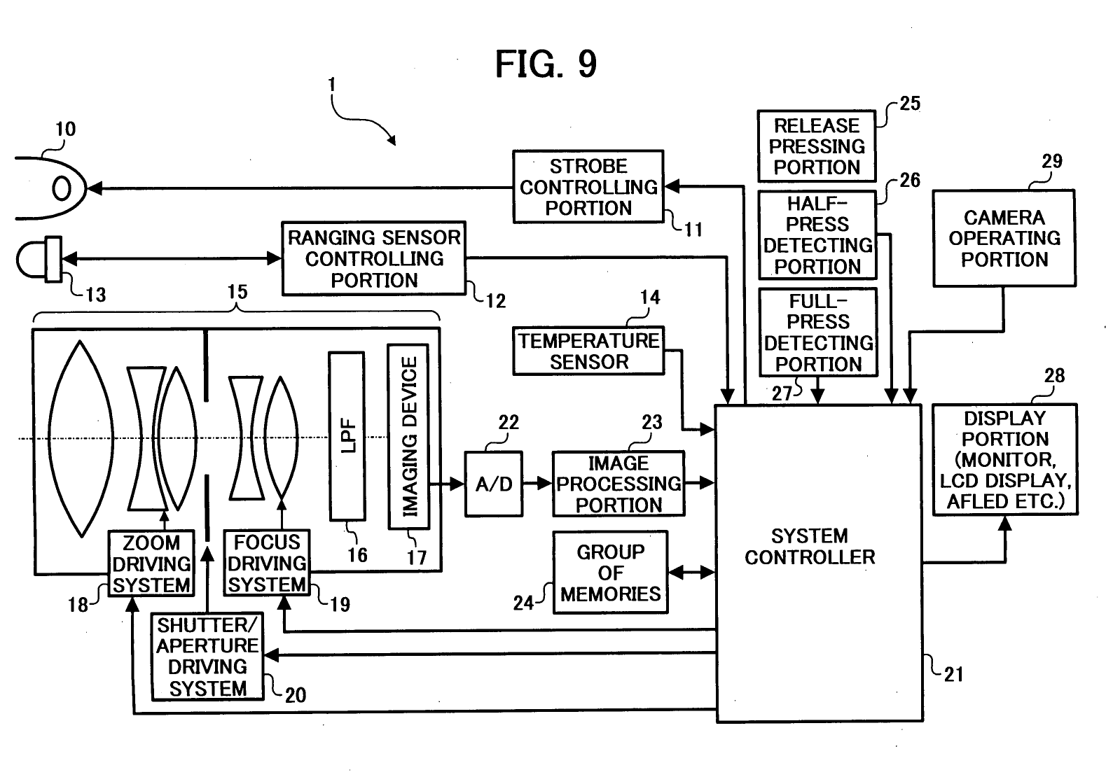

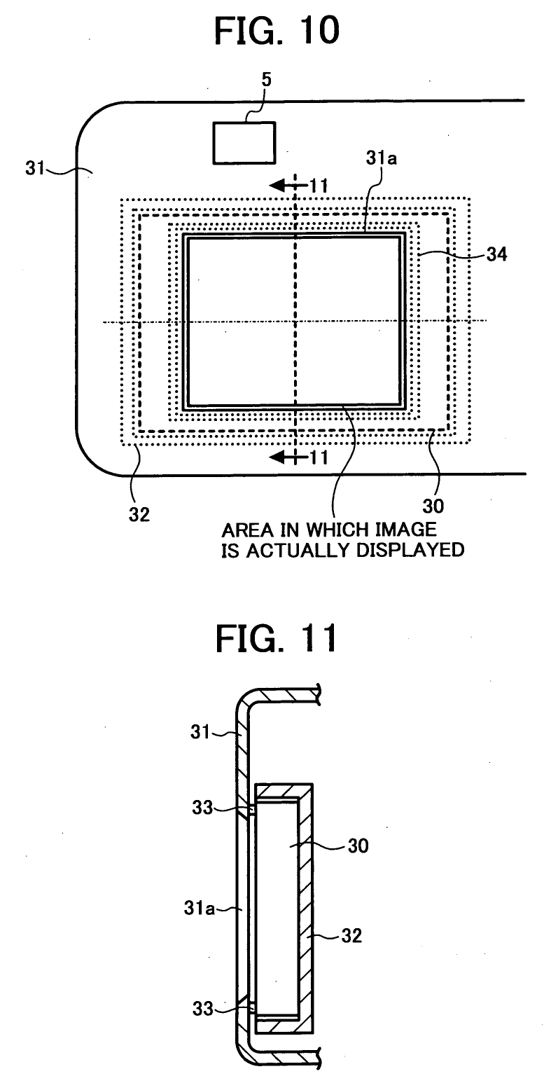

FIG. 4 is an enlarged back view showing the vicinity of the liquid crystal unit according to a second embodiment of the present invention of the digital camera. FIG. 5 is a cross-sectional view taken along a line C-C in FIG. 4. FIG. 6 is a cross-sectional view taken along a line D-D in FIG. 4.

Subsequently, description on the second embodiment of the present invention will be given with reference to FIGS. 4 to 6. A basic concept of the second embodiment is same as that of the first embodiment mentioned above. However, in the second embodiment, it is configured that upper and lower portions of the liquid crystal unit 30 is constrained by the opening 31a of the back cover 31 and portions in the right and left directions (edges) of the liquid crystal protective panel 6 are constrained by the liquid crystal fixing frame 32, and the “grid” shape is arranged to be opposite as compared with the first embodiment as shown in FIG. 1.

The second embodiment of the present invention has an advantage different to that of the first embodiment as will be described hereinafter. However, since the basic concept is same as the first embodiment, the effect of the second embodiment is same as the ones mentioned above.

Although a size of the liquid crystal fixing frame 32 inside the camera illustrated in the drawings of the second embodiment is substantially equivalent to the size of the liquid crystal fixing frame 32 illustrated in the drawings of the first embodiment, it is possible to eliminate a portion of the shape of the liquid crystal fixing frame 32 where does not overlap with the liquid crystal protective panel 6, since aims of the liquid crystal unit supporting frame 32 are to receive the liquid crystal unit 30 and to receive the liquid crystal protective panel 6 with upper and lower portions or right and left portions of the liquid crystal unit supporting frame 32.

In other words, it is possible to reduce the size in the right and left directions according to the second embodiment, which makes it advantages in a camera having a narrow width.

Although the invention has been described in its preferred form with a certain degree of particularity, it should be noted that in the present invention is not limited by the embodiments described in the foregoing, and obviously many changes and variations are possible therein.

For example, a plurality of elongated rectangular two-sided tapes such as four pieces of two-sided tapes, or a square frame-shaped two-sided tape may be used as the adhesive member 34. Also, an adhesive material may be initially applied on a back surface of the liquid crystal protective panel 6 in a frame shape, rather than using the two-sided tape.

The liquid crystal unit fixing member may be a molded member structuring the camera body, or may be a metal plate chassis member coupling built-in components of the camera.

Furthermore, although the present invention is suitable for the commonly-used digital camera, it is also possible to apply the present invention to a horizontal digital camera and to a digital camera in which a liquid crystal portion is rotated, and also to electronic devices in general utilizing a liquid crystal display unit.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A protective structure for a display unit, comprising:
the display unit for displaying an image, and
a plate-like protective member disposed at a side of a surface of the display unit on which the image is displayed for protecting the display surface of the display unit, wherein
the protective member is directly fixed to the display unit.

2. The protective structure for the display unit according to claim 1, wherein either one of a size in a longitudinal direction and a size in a lateral direction of the protective member is smaller than a corresponding outline size of the display unit.

3. The protective structure for the display unit according to claim 1, further comprising a cover member covering periphery of the display unit, wherein the display unit is disposed to be constrained by the cover member with respect to a direction perpendicular to the display surface at a portion of the display unit larger than a size of the protective member.

4. The protective structure for the display unit according to claim 1, further comprising a retaining member for retaining the display unit, wherein the retaining member is disposed to constrain the protective member with respect to a direction perpendicular to the display surface at a portion of the retaining member larger than a size of the display unit.

5. The protective structure for the display unit according to claim 2, further comprising a retaining member for retaining the display unit, wherein the retaining member is disposed to constrain the protective member with respect to a direction perpendicular to the display surface at a portion of the retaining member larger than a size of the display unit.

6. The protective structure for the display unit according to claim 3, further comprising a retaining member for retaining the display unit, wherein the retaining member is disposed to constrain the protective member with respect to a direction perpendicular to the display surface at a portion of the retaining member larger than a size of the display unit.

7. The protective structure for the display unit according to claim 1, further comprising a cover member covering periphery of the display unit, wherein the protective member is disposed such that a position in a longitudinal direction and/or a position in a lateral direction of the protective member are/is constrained by an opening portion of the cover member.

8. The protective structure for the display unit according to claim 2, further comprising a cover member covering periphery of the display unit, wherein the protective member is disposed such that a position in the longitudinal direction and/or a position in the lateral direction of the protective member are/is constrained by an opening portion of the cover member.

9. The protective structure for the display unit according to claim 3, wherein the protective member is disposed such that a position in the longitudinal direction and/or a position in the lateral direction of the protective member are/is constrained by an opening portion of the cover member.

10. The protective structure for the display unit according to claim 1, wherein the protective member is fixed to the display unit by an adhesive member having a configuration generally surrounding a display area of the display unit.

11. The protective structure for the display unit according to claim 2, wherein the protective member is fixed to the display unit by an adhesive member having a configuration generally surrounding a display area of the display unit.

12. The protective structure for the display unit according to claim 3, wherein the protective member is fixed to the display unit by an adhesive member having a configuration generally surrounding a display area of the display unit.

13. A digital camera comprising the protective structure for the display unit according to claim 1.

14. A digital camera comprising the protective structure for the display unit according to claim 2.

15. A digital camera comprising the protective structure for the display unit according to claim 3.

16. A digital camera comprising the protective structure for the display unit according to claim 4.

17. A digital camera comprising the protective structure for the display unit according to claim 5.

18. A digital camera comprising the protective structure for the display unit according to claim 6.

19. A digital camera comprising the protective structure for the display unit according to claim 7.

20. A digital camera comprising the protective structure for the display unit according to claim 8.

21. A digital camera comprising the protective structure for the display unit according to claim 9.

22. A digital camera comprising the protective structure for the display unit according to claim 10.

23. A digital camera comprising the protective structure for the display unit according to claim 11.

24. A digital camera comprising the protective structure for the display unit according to claim 12.

25. An image-related apparatus comprising the protective structure for the display unit according to claim 1.

26. An image-related apparatus comprising the protective structure for the display unit according to claim 2.

27. An image-related apparatus comprising the protective structure for the display unit according to claim 3.

28. An image-related apparatus comprising the protective structure for the display unit according to claim 4.

29. An image-related apparatus comprising the protective structure for the display unit according to claim 5.

30. An image-related apparatus comprising the protective structure for the display unit according to claim 6.

31. An image-related apparatus comprising the protective structure for the display unit according to claim 7.

32. An image-related apparatus comprising the protective structure for the display unit according to claim 8.

33. An image-related apparatus comprising the protective structure for the display unit according to claim 9.

34. An image-related apparatus comprising the protective structure for the display unit according to claim 10.

35. An image-related apparatus comprising the protective structure for the display unit according to claim 11.

36. An image-related apparatus comprising the protective structure for the display unit according to claim 12.
